(19) United States
(12) Patent Application Publication
(10) Pub. No.: US 2006/0012974 A1
(43) Pub. Date: Jan. 19, 2006

(54) Multifunctional glasses

(76) Inventor: Chi-Yang Su, Chung-Ho (TW)

Correspondence Address: G' LINK COMPANY;Suite 137, PmB 174, 931 West 75th Street, Naperville, IL, 60565, US

(21) Appl. No.: 10/892,566

(22) Filed: Jul. 16, 2004

(51) Int. Cl. F21V 21/084

(52) U.S. Cl. 362/105

(57) ABSTRACT

A pair of multifunctional glasses includes a front frame and two side frames. The front frame has a chamber being provided at least at one of the two lateral ends thereof for receiving a luminous member and a recess is provided at least at the front end of one of the side frames to be arranged with a power control part corresponding to the luminous member. Hence, the luminous member can be turned on in case of the side frames being unfolded and the power control part touching the luminous member and the luminous member is turned off in case of the side frames being folded and the power control part detaching from the luminous member.

### BACKGROUND OF THE INVENTION

1. Field of The Invention:

The present invention relates to a pair of multifunctional glasses and particularly to a pair of glasses, which provides a special structure with multiple functions.

2. Description of Related Art

Usually, glasses are used for correcting defects of vision such as near-sight, presbyopia and astigmatism, or for isolating foreign harmful light such as ultraviolet rays. Generally, design for glasses is mostly emphasized on profiling or components of the glasses to enhance visual aesthetic feeling and wearing comfort. A front frame of the glasses has two rims for fixing lens with a pair of nosepieces at the middle part thereof. a pair of pivotal side frames extending rearward from two lateral sides of the front frame respectively so that the entire glasses can be supported with nose and ears to constitute four-point locating. Hence, the front frame and the side frames are indispensable components for glasses.

However, functional disorder such as strabismus or amblyopia is not possible to be corrected with the ordinary glasses. Although strabismus and amblyopia are not belonged to symptoms of vision, the appearance of the patient could be affected seriously and it results in the patient being self-abased. Generally, strabismus and amblypia are cured by way of following methods. (a) wearing specially made glasses such as dual lighting glasses and a prism being added to the lens for images of two eyes being closer when necessary and (b) vision training being made in case of the patient finding double images, which are generated from sight axes of the two eyes being not aligned for joining the two images as single image. Hence, how to design glasses providing effect of sight training instead of specially made glasses is a subject worth to be overcome by the manufacturers.

Glasses with an illuminator at two lateral sides thereof are mostly used where the illumination is poor. For instance, Taiwanese Patent Gazette No. 488711 discloses a magnetic piece being arranged two lateral sides of the glasses and the illuminator is joined to the magnetic piece respectively. Further, the illuminator has a lighting part and a magnetic joining part with a switch component for controlling on and off of the lighting part. The illuminator can be detached from the glasses and used separately. Therefore, the illuminator on the prior art can be either joined to the glasses or detached from the glasses for offering function of lighting. Besides, the illuminator is mostly detachably joined to the glasses instead of being joined integrally with the glasses.

### SUMMARY OF THE INVENTION

The crux of the present invention is to provide a pair of glasses with at least an integrally attached luminous member for offering functions such as performing physical treatment, safety indication, funny presentation and illumination at night.

Accordingly, glasses according to the present invention includes a front frame and two side frames, wherein, a chamber is provided in the front frame at least at one of the two lateral ends thereof for receiving a luminous member and a recess is provided at least at the front end of one of the side frames to be arranged with a power control part corresponding to the luminous member. Hence, the luminous member can be turned on in case of the side frames being unfolded and the power control part touching the luminous member and the luminous member is turned off in case of the side frames being folded and the power control part detaching from the luminous member.

Next, the glasses according to the present invention have the front frame thereof includes a chamber, being provided at least at one of the two lateral ends thereof for receiving a luminous member; a frame room, receiving two electrode plates and at least a cell; a rear wire slot, receiving two lead wires, which are coupled to the luminous member; a knob, being movably attached to the frame room; and a rear cover plate, closing the rear wire slot. Hence, the luminous member can be turned on or off by way of the knob being operated to allow the electrode plates touching or detaching the cell.

Further, the glasses according to the present invention to have the frame room thereof with a conductive button, which has a on and mode selection button part and a off button part on the surface thereof, and an integrated circuit, which is received in the frame room and has a microprocessor, a cell and two joints corresponding to the on and mode selection button part and the off button part respectively. Hence, the luminous member can be turned on or off and perform different functions by way of pressing the conductive button.

### BRIEF DESCRIPTION OF THE DRAWINGS

The present invention can be more fully understood by reference to the following description and accompanying drawings, in which:

FIGS. 1 and 2 are exploded perspective views of multifunctional glasses according to the present invention in a first embodiment thereof;

FIG. 3 is a perspective view of the first embodiment according to the present invention;

FIGS. 4a and 4b are fragmentary views illustrating a luminous member is attached to the glasses in the first embodiment of the present invention;

FIG. 5 is a fragmentary perspective view illustrating a power control part of the first embodiment according to the present invention;

FIGS. 6 and 7 are perspective views of the second embodiment according to the present invention;

FIGS. 8 and 9 are fragmentary perspective views illustrating a power control part of the second embodiment according to the present invention;

FIG. 10 is a perspective view of the second embodiment;

FIG. 11 is a perspective view of the third embodiment; and

FIG. 12 is a block diagram of a integrated circuit in the third embodiment.

### DETAILED DESCRIPTION OF THE PREFERRED EMBODIMENTS

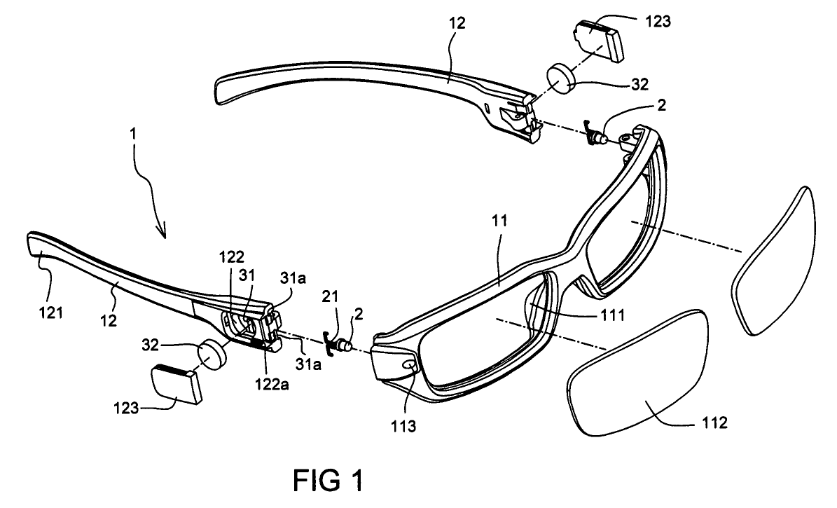

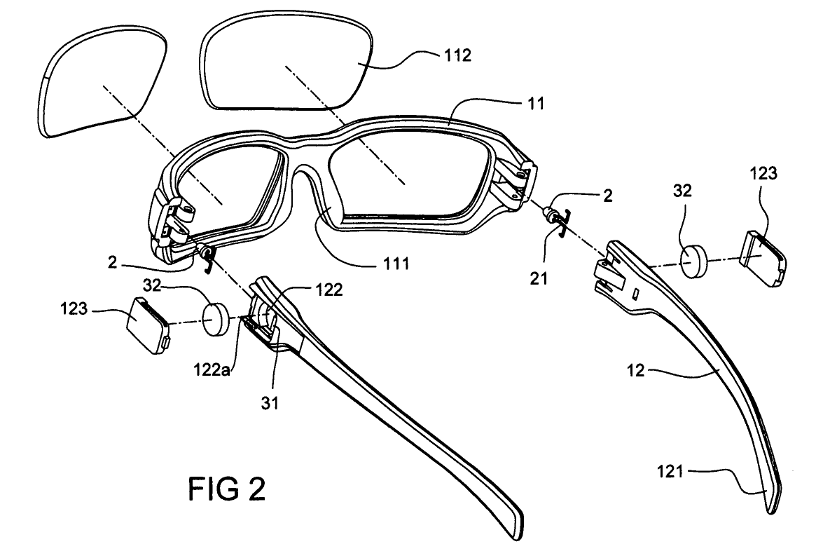

With reference to FIGS. 1 to 5, basically a pair of multifunctional glasses 1 according to the present invention includes at least a luminous member 2 and a power control part 3. The glasses 1 can be ordinary vision correction type glasses or a specific function type glasses such as sunglasses, glasses for sporting and glasses for working.

Wherein, the glasses 1 provide a front frame 11 for fitting lens 112 and two elongated side frames 12. A nosepiece part 111 is located at the middle of the front frame 11. These are essential parts for glasses and no detail will be described further.

The front frame 11 is provided with at least a chamber 113 for receiving and locating the luminous member 2 and it is preferable that the chamber 113 is disposed at a lateral side of the front frame 11 as shown in the figures and the luminous member 2 preferably is a light emit diode (LED) such as red, blue and green multi-chip type LED for generating single color light or mixed color light or ultraviolet ray type LED for adaptable with different functions while in use.

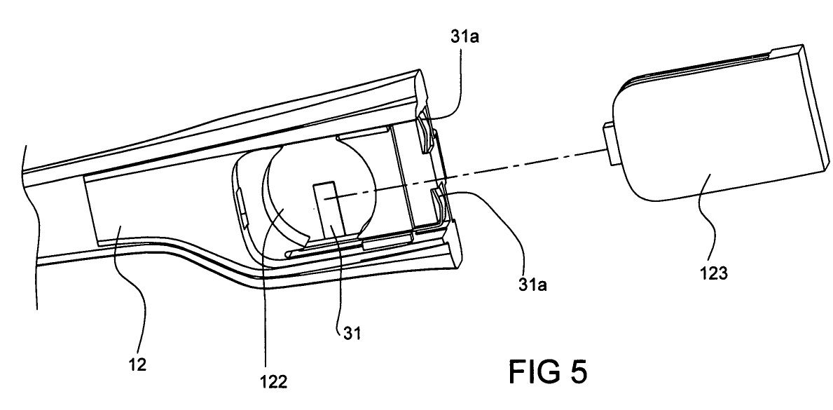

The power control part 3 supplies power required by the luminous member 2 and controls the luminous member 2 being on or off. The power control part 3 is disposed in a recess 122 at the front end of each side frame 12 as shown in FIGS. 1 and 5. The recess 122 has a guide groove 122a at the upper side and lower side thereof for being inserted with two electrodes 31 with the conductive ends 31a being perpendicular to the side frames 12 for at least a cell 32 being placed in the recess 122 contacting the conductive ends 31a. A cover 123 is used for closing the recess 122 to complete assembly of the power control part 3.

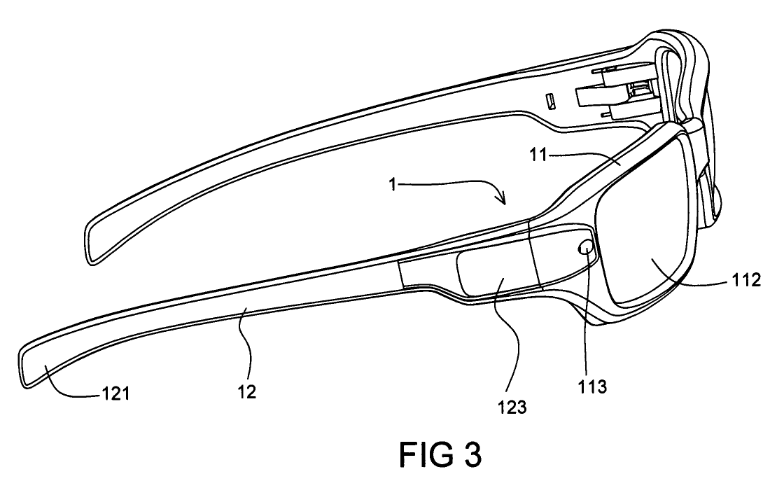

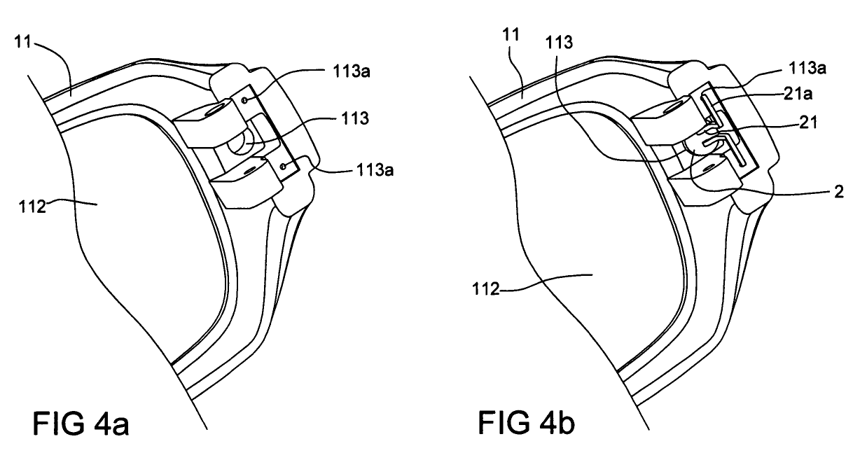

It can be seen in FIGS. 4a and 4b that the luminous member 2 received in the chamber 113 provides two pins 21 being bent outward to form a U shape respectively and being inserted into a pin hole 113a at the rear side of the chamber 113 so that the two pins 21 constitute a contact end 21a respectively. When the two side frames 12 are folded up, the power control part 3 at the conductive ends 31a is detached from the contact ends 21a of the luminous member 21a as a state of open circuit. When the two side frames 12 are unfolded as shown in FIG. 3, the two conductive ends 31a contact with the contact ends 21a as a state of close circuit and the luminous member 2 is lit up immediately. Hence, an advantage of the present embodiment is that there is no switch necessary for power the control part 3 and the luminous member 2 is turned on or off merely depending on the side frame 12 being folded up or unfolded.

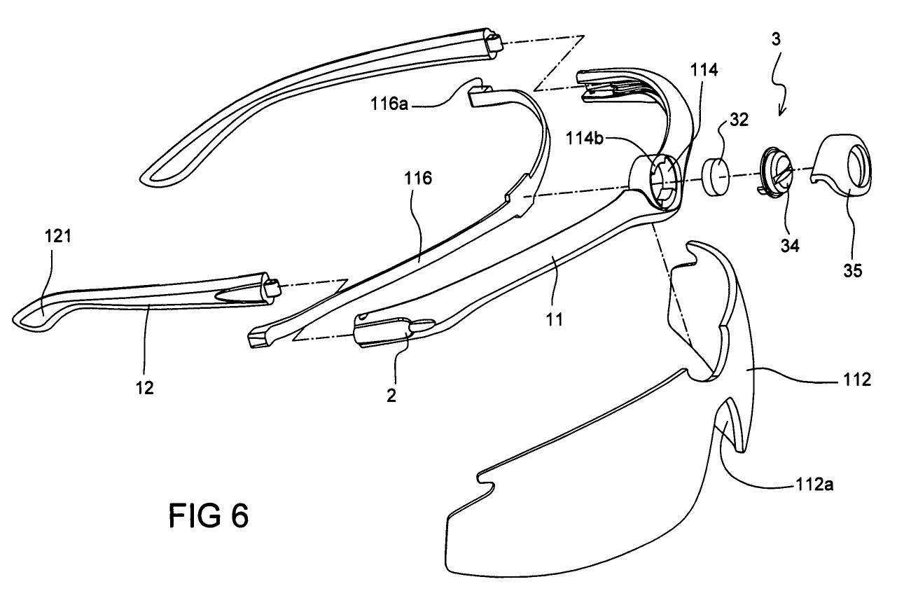

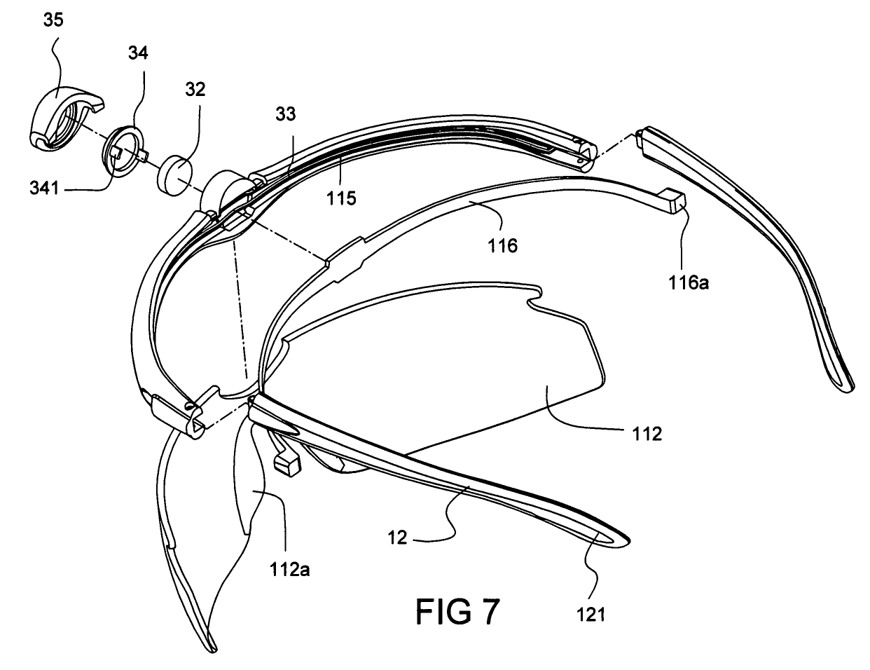

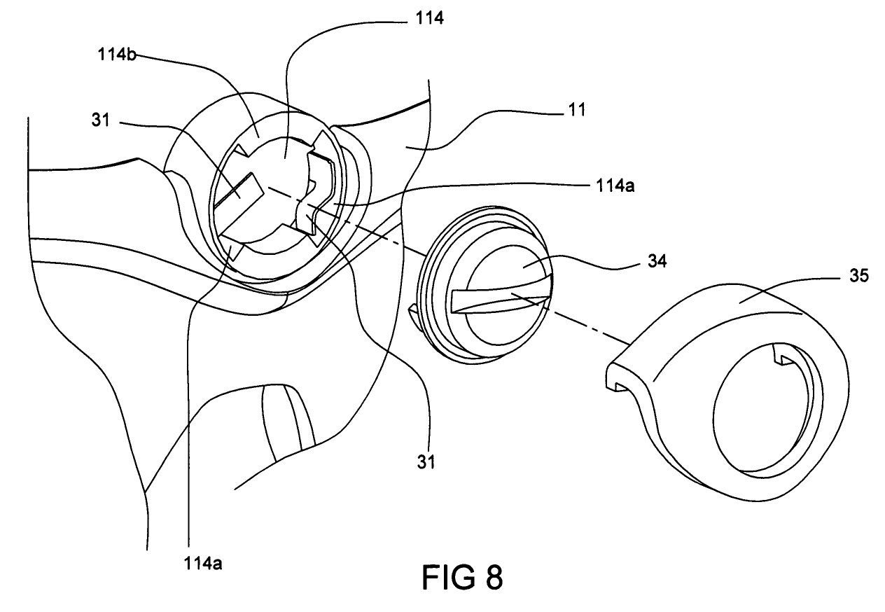

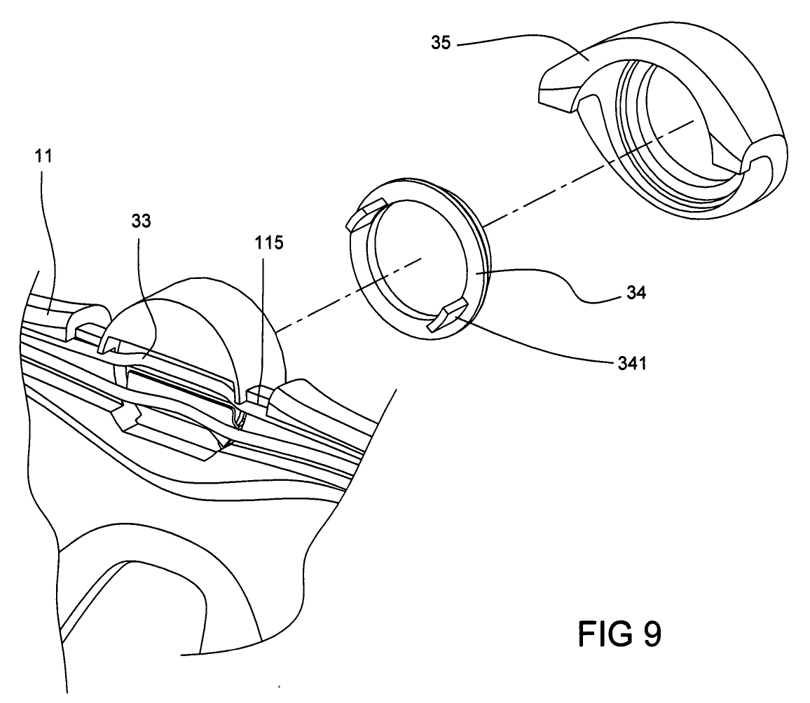

Referring to FIGS. 6 to 10, the second embodiment of the present invention is illustrated. The power control part 3 is disposed at a frame room 114 of the front frame 11 with two opposite lateral guide grooves 114a being arranged at the rim of the frame room 114 for receiving and locating two electrode plates 31. The electrode plates 31 at the rear side thereof is coupled to two lead wires 33 in a transverse wire slot 115 in the front frame 11 and connected to a luminous member 2 in chambers 113 at two opposite lateral sides of the front frame 11. The wire slot 115 is closed with a rear cover 116 and the rear cover 116 is located in place by way of engaging tenons 116a at both ends thereof inserting into the end part of the wire slot 115.

The frame room 114 is received with a cell 32 and then closed with a knob 34. The frame room 114 at the top and the bottom thereof extends inward a stopper 114b respectively and the knob 34 is provided with at least a stir projection 341 extending inward from the perimeter thereof. Once the knob 34 is turned along a direction, the stir projection 341 can press or release one of the electrode plates 31 so as to touch or detach the cell. Under this circumstance, the luminous member can be turned on or off. Besides, a hollow shield 35 is disposed to surround the knob 34 and is joined to the frame room 114 such that it can enhance the effect of decoration in addition to preventing the knob 34 from loosening.

In fact, it is preferable that the luminous member 34 is located at two opposite lateral sides of the glasses 1 and the advantages are listed underneath:

(1) The glasses of the present invention can perform physical treatment: The glasses of the present invention can be used for curing the functional disorder such as strabismus or amblyopia. After the luminous members at right and left sides of the eyes being lit up, both eyes can stare at the luminous members sufficiently and evenly to avoid the vision deficiency resulting from strabismus and amblyopis or mitigate the functional disorder of strabismus or amblyopia

(2) The glasses of the present invention is helpful for working or reading in an environment of insufficient brilliance: If the luminous member is LED with high light intensity, it can be used as lighting at night or under a condition of poor illumination to facilitate work or reading. Comparing to illuminator worn at the forehead, the glasses of the present invention can lessen disturbing to others in addition to being carried about easily. Further, the glasses of the present invention is smaller in size and it is suitable for tiny and sophisticate job.

(3) The glasses of the present invention provides safety indication and interesting symbol: The front frame and the side frame can be transparent and filled with bubbles or fiber optical wires and the luminous members can be multi-chip type LED with red, blue and green colors while in practice. As a result, it can create color changes between single and mixed color being projected to the front frame and/or the side frames as safety indication and identification moving at night such as taking night exercise or changing amusing colors in a night party.

(4) The glasses of the present invention provides a function of recognition: If the luminous member is ultraviolet light type LED, the glasses of the present invention can be used for detecting counterfeit currency. Hence, when the LED is lit up, fluorescent lines and implicative figures on the paper bills can be identified as being authentic or false.

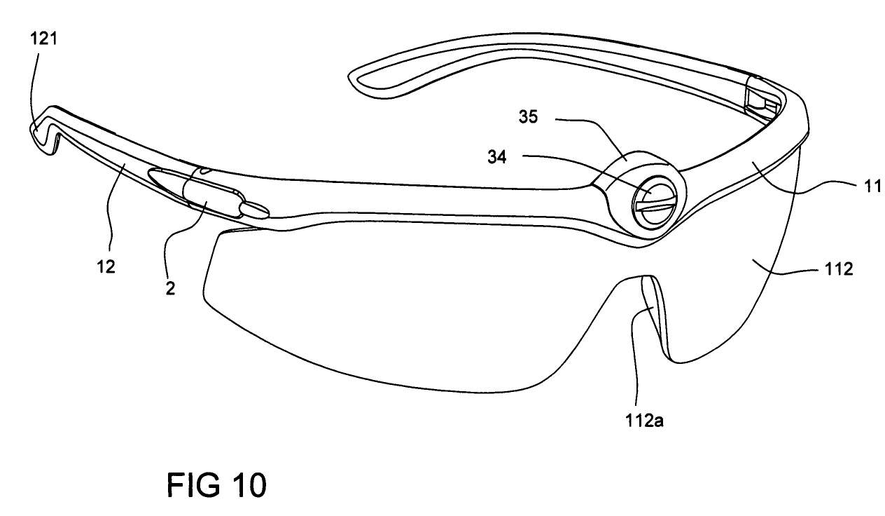

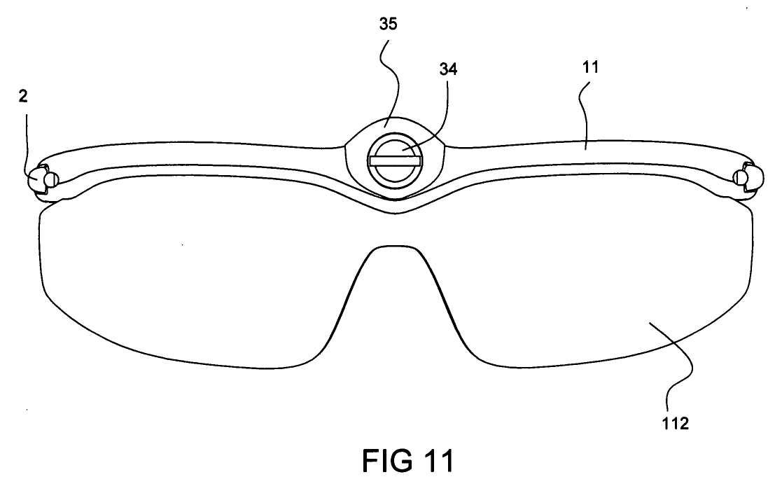

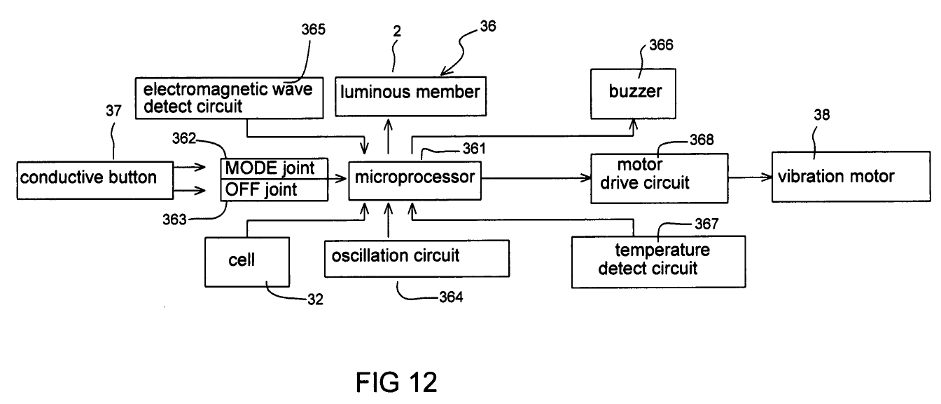

Referring to FIGS. 10 and 11, the third embodiment is illustrated. Most part of the present embodiment is similar to the second embodiment and the difference of the present embodiment is in that a micro integrated circuit instead of the knob. The integrated circuit 36 has a microprocessor 361 with a battery 32 as the power source and two joints 362, 363. The joint 362 is for on the luminous member and mode selection and the joint 363 is for off the luminous member. Either on-mode selection half button part or off half button part of the conductive button 37 on the surface of the frame room 114 can be pressed for turning on the luminous member and selecting function modes such as the luminous member performing color changing or red color twinkling or for turning off the luminous member.

The preceding mode selection is operated by way of the microprocessor 361 being coupled to an oscillation circuit 364 such that the luminous member 2 can provide a function of twinkling or color changing. Meanwhile, the integrated circuit 36 can be coupled to an electromagnetic sensing circuit 365 for detecting ambient electromagnetic wave and the microprocessor 361 orders a buzzer 366 to emit alarm as warning in case of the electromagnetic wave exceeding a default value set in the microprocessor 361. Besides, the integrated circuit is further coupled to a non-touch type temperature detect circuit 367 to detect surface temperature on the forehead of the user and a signal can be sent to the microprocessor in case of the temperature exceeding a preset constant (38.5° C.) and it allows the luminous member 2 to generate red inner flash light to signal the user having a fever.

Furthermore, the frame room 114 can be added a small vibration motor 38 and the circuit board 36 has a motor drive circuit 368 coupled to the vibration motor 38. Once the joint 362 is switched to massage function, the microprocessor 361 actuates the motor 38 to run via the motor drive circuit 368 so as to massage acupuncture points between eyes and above nose for relaxing exhausted eyes.

While the invention has been described with reference to preferred embodiments thereof, it is to be understood that modifications or variations may be easily made without departing from the spirit of this invention, which is defined by the appended claims.

What is claimed is:

1. A pair of multifunctional glasses, comprising:
a front frame with two lateral ends, being attached with lens; and
two elongated side frames, having front ends therefore being pivotally joined to the lateral ends of the front frame respectively;
wherein, a chamber is provided in the front frame at least at one of the two lateral ends thereof for receiving a luminous member and a recess is provided at least at the front end of one of the side frames to be arranged with a power control part corresponding to the luminous member;
whereby, the luminous member can be turned on in case of the side frames being unfolded and the power control part touching the luminous member and the luminous member is turned off in case of the side frames being folded and the power control part detaching from the luminous member.

2. The multifunctional glasses as defined in claim 1, wherein the chamber is provided at the two lateral ends of the front frame for receiving the luminous member respectively.

3. The multifunctional glasses as defined in claim 1, wherein the luminous member is a light emitting diode (LED) and the LED can be multi-chip type with red, blue and green colors or ultraviolet ray type.

4. The multifunctional glasses as defined in claim 1, wherein the front frame and the side frames can contain bubbles, fiber optical wires or explicated marks such as characters and figures.

5. The multifunctional glasses as defined in claim 1, wherein the recess at the front end of the side frame has a guide groove at the upper side and lower side thereof respectively for locating the power control part and the power control part has two electrode plates being inserted into the guide grooves for touching the luminous member, at least a cell being received in the recess contacting with the electrode plates and a cover closing the recess to complete the power control part.

6. The multifunctional glasses as defined in claim 5, wherein the electrode plates have a bent contact end extending outward respectively to be perpendicular with the front end of the side frame and the chamber has two pin holes at the rear side thereof for being passed through with two pins of the luminous member corresponding to the pins for the pins being capable of touching the bent contact ends.

7. A pair of multifunctional glasses, comprising:
a front frame with two lateral ends, being attached with lens;
two elongated side frames, having front ends therefore being pivotally joined to the lateral ends of the front frame respectively;
wherein, the front frame further comprises:
a chamber, being provided in the front frame at least at one of the two lateral ends thereof for receiving a luminous member;
a frame room, receiving two electrode plates and at least a cell;
a rear wire slot, receiving two lead wires, which are coupled to the luminous member;
a knob, being movably attached to the frame room; and
a rear cover, closing the rear wire slot;
whereby, the luminous member can be turned on or off by way of the knob being operated to make the electrode plates touching or detaching the cell.

8. The multifunctional glasses as defined in claim 7, wherein the frame room at the top and the bottom thereof extends inward a stopper respectively and the knob is provided with at least a stir projection extending inward from the perimeter thereof such that once the knob is turned along a direction, the stir projection can press or release one of the electrode plates so as to touch or detach the cell.

9. The multifunctional glasses as defined in claim 7, wherein a hollow shield is disposed to surround the knob and is joined to the frame room so as to expose part of the knob for being operated.

10. The multifunctional glasses as defined in claim 7, wherein the chamber is provided at the two lateral ends of the front frame for receiving the luminous member respectively.

11. The multifunctional glasses as defined in claim 7, wherein the luminous member is a light emitting diode (LED) and the LED can be multi-chip type with red, blue and green colors or ultraviolet ray type.

12. The glasses as defined in claim 7, wherein the front frame and the side frames can contain bubbles, fiber optical wires or explicated marks such as characters and figures.

13. A pair of glasses, comprising:
a front frame with two lateral ends, being attached with lens;
two elongated side frames, having front ends therefore being pivotally joined to the lateral ends of the front frame respectively;
wherein, the front frame further comprises:
a chamber, being provided in the front frame at least at one of the two lateral ends thereof for receiving a luminous member;
a frame room, having a conductive button with an on and mode selection half button part and an off button part on the surface thereof;
a rear wire slot, receiving two lead wires, which are coupled to the luminous member;
an integrated circuit, being received in the frame room and having a microprocessor with a cell and two joints corresponding to the on and mode selection half button part and the off button part of the conductive button respectively; and
a rear cover, closing the rear wire slot;
whereby, the luminous member can be turned on or off and perform different functions by way of pressing the conductive button.

14. The glasses as defined in claim 13, wherein an oscillation circuit is coupled to the microprocessor to enable the luminous twinkling.

15. The glasses as defined in claim 13, wherein an electromagnetic wave sensing circuit is coupled to the microprocessor to enable the microprocessor sending a signal for a buzzer being actuated to emit warning once the electromagnetic wave exceeds a default built in the microprocessor.

16. The glasses as defined in claim 13, wherein a non-touch type temperature detecting circuit is coupled to the microprocessor to enable the microprocessor sending a signal for lighting up the luminous member.

17. The glasses as defined in claim 13, wherein a vibration motor is provide in the frame room with a motor driving circuit being coupled to the microprocessor to enable the vibration motor running with changing frequencies.

18. The glasses as defined in claim 13, wherein the chamber is provided at the two lateral ends of the front frame for receiving the luminous member respectively.

19. The glasses as defined in claim 13, wherein the luminous member is a light emitting diode (LED) and the LED can be multi-chip type with red, blue and green colors or ultraviolet ray type.

20. The glasses as defined in claim 13, wherein the front frame and the side frames can contain bubbles, fiber optical wires or explicated marks such as characters and figures.
